(19) United States
(12) Patent Application Publication
(10) Pub. No.: US 2026/0045066 A1
(43) Pub. Date: Feb. 12, 2026

(54) NUANCED TARGET RECOGNITION

(71) Applicant: The Charles Stark Draper Laboratory, Inc., Cambridge, MA (US)

(72) Inventor: Anthony Palladino, Cambridge, MA (US)

(21) Appl. No.: 19/291,018

(22) Filed: Aug. 5, 2025

Related U.S. Application Data
(60) Provisional application No. 63/679,703, filed on Aug. 6, 2024.

(51) Int. Cl. G06V 10/764

(52) U.S. Cl. CPC G06V 10/764

(57) ABSTRACT

A system for nuanced target recognition, comprising one or more processors coupled with memory, the one or more processors may be configured to detect, using a second model, an object based on a sequence of images, determine, using the second model, a class of the object for one or more of the images of the sequence of images, based on the images and an output of a first model, wherein the output comprises class definitions associated with a plurality of objects, generate a classification of the object based on the determined classes for the one or more images, and present the object and the classification on a display coupled with the one or more processors.

### CROSS-REFERENCE TO RELATED APPLICATIONS

This application claims the benefit of U.S. provisional application Ser. No. 63/679,703 filed Aug. 6, 2024, the disclosure of which is hereby incorporated in its entirety by reference herein.

### TECHNICAL FIELD

Aspects of the disclosure generally relate to systems and methods for detecting and classifying objects in images. More specifically, Automatic Target Recognition (ATR) systems are described herein using open-vocabulary object detection and classification models

### BACKGROUND

Objects can be recognized in images. Detected objects in images can be classified into a set of desired labels, i.e., classes. Current systems are typically limited to fixed inputs, including fixed vocabulary, or a fixed set of object claims.

### SUMMARY

Presented herein is a system for nuanced target recognition. The system includes one or more processors coupled with memory. The one or more processors may be configured to detect, using a second model, an object based on a sequence of images, determine, using the second model, a class of the object for one or more of the images of the sequence of images, based on the images and an output of a first model. The output includes class definitions associated with a set of objects. The system cab generate a classification of the object based on the determined classes for the one or more images, and present the object and the classification on a display coupled with the one or more processors.

Presented herein is a method for nuanced target recognition. The method may include receiving a sequence of images, receiving a natural language description of a desired object, analyzing the natural language description and generating a feedback interface including at least one initial classification and at least one adjustment option, receiving adjustments in response to the feedback interface, refining initial classification based on the adjustments, and providing the refined classification for object detection within the sequence of images.

Presented herein is a non-transitory computer-readable medium having instructions embodied thereon. The instructions may cause one or more processors to identify an object based on a sequence of images, identify, for each of the one or more images of the sequence of images, a bounding box around the object, generate a tubelet of multiple ones of the sequence of images, overlay a Gaussian Kernel Density Estimate proportional to the dimensions of each bounding box, and aggregate the ones of the sequence of images including the object based on the overlay to generate a heat map representation of overlapping frames.

### BRIEF DESCRIPTION OF THE DRAWINGS

The foregoing and other objects, aspects, features, and advantages of the disclosure will become more apparent and better understood by referring to the following description taken in conjunction with the accompanying drawings. The accompanying drawings are not intended to be drawn to scale. Like reference numbers and designations in the various drawings indicate like elements. For purposes of clarity, not every component may be labeled in every drawing. In the drawings:

FIG. 1 illustrates a system for receiving an input, defining classes, and detecting and classifying objects within a sequence of images for nuanced target recognition.

FIG. 2 illustrates a system for generating a tubelet and map based on the association of one or more objects with the classes for nuanced target recognition;

FIG. 3 illustrates an example target recognition system; and

FIG. 4 illustrates a block diagram of a computing environment according to an example implementation of the present disclosure.

FIG. 5 illustrates a process diagram of an iterative feedback mechanism for enhancing natural language class descriptions.

FIG. 6 illustrates an example user interface for the iterative feedback mechanism, showing multiple ways in which the user can update the class description embeddings.

FIG. 7 illustrates improvements in desired target object detection after incorporating our system's feedback.

FIGS. 8A and 8B illustrate examples of problematic mosaics built from the same set of video frames with FIG. 8A being built from the top frame down and FIG. 8B being built from the bottom frame up, highlighting the diminution (or expansion) problem when the initial image was captured from a tilted camera.

FIG. 9 illustrates an example of the system output mosaic.

FIG. 10 illustrates a table listing example classes, text descriptions, and image exemplars for a notional application of nuanced target recognition system applied to UXO detection.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Reference will now be made to the embodiments illustrated in the drawings, and specific language will be used here to describe the same. It will nevertheless be understood that no limitation of the scope of the disclosure is thereby intended. Alterations and further modifications of the features illustrated here, and additional applications of the principles as illustrated here, which would occur to a person skilled in the relevant art and having possession of this disclosure, are to be considered within the scope of the disclosure.

An Automatic Target Recognition (ATR) system is described herein using open-vocabulary object detection and classification models. The system allows for target classes to be defined before runtime by a non-technical end user, using either a natural language text descriptions of the target and/or image examples. Allowing end users to use natural languages may be useful for unique targets and without requiring specific training data. The system may use a combination of leveraging the additional information in the sequence of overlapping frames to perform tubelet identification (i.e., sequential bounding box matching), bounding box re-scoring, and tubelet linking. Additionally, or alternatively, the system may allow for visualization of the aggregate output of many overlapping frames as a mosaic of the area scanned during an aerial surveillance or reconnaissance, and a kernel density estimate (or heatmap) of the detected targets.

Specifically, in some cases, detection of objects unknown to a traditional image recognition model can result in faulty classifications of the objects due to the limited visual features available to conventional image recognition models. Traditional image recognition models receive a set of images and their associated class labels to train a model using architectures such as neural networks or vision transformers prior to deployment of the model. In cases where an unknown object is encountered by the traditional model during deployment, the model fails and would require retraining if a user wants to incorporate the new object class. Further, in instances where models are trained on a very large number of classes to minimize the likelihood of encountering an unknown object, a traditional image recognition system can suffer from data loss, latency, and large amounts of requisite storage and processing power.

Additionally, because training data is required to add new classes to conventional systems, current systems further suffer from low-quality, few, or even non-existent exemplars for defining new object classes. Exemplars provided during training or retraining for conventional image recognition models can suffer from a lack of distinction between information used to differentiate between object classes. In this manner, current target recognition systems utilizing models trained with a fixed class list suffer due to the lack of ability to recognize new classes outside of the initial training set and without curated input.

To account for these and other technical problems, an open-vocabulary multimodal language model (MMLM), also known as a Vision-Language Model (VLM), can detect objects based on the semantic knowledge in the underlying model. The system described herein can accept multimodal input such as images, videos, text, etc., to define modality-agnostic classes. This semantic understanding allows the system to recognize new classes even if some nuances (i.e., small discrepancies or changes) in the new classes were not included in the original model's training data. For example, wide types of natural language descriptions, such as including slang, colloquialisms, or assorted vernacular within the training data or later input do not inhibit the system described herein from recognizing new classes. Further, the system can provide feedback to the user about the class definitions to receive more distinguishing input as well as to curate and properly account for any duplicitous, erroneous, or otherwise faulty input received.

In this manner, the system and methods described herein do not need to be retrained for each new object encountered and can update or define an object class at run time, sans input, with the MMLM. Further, the system can, at run time and without retraining, accept and curate input for potentially new objects that the system may encounter. The system can encounter new objects, for example, when using the system in a new location, or if a known object is disguised, masked, or otherwise altered in appearance. This removes the need for training data images to add new classes to the model, as the MMLM can understand new class definitions based on the semantic knowledge in the model. Therefore, the systems and methods described herein can receive exemplar images for defining a new class, but do not necessitate those exemplar images for addition of new classes, thereby bypassing annotation-style training common in traditional image recognition systems. This provides a flexibility and adaptability to adjust the desired targets to detect at run time, using text descriptions and/or image exemplars from any image modality (e.g., electro-optical, infrared, etc.).

Furthermore, the systems and methods described herein can classify an object in a video on a frame-by-frame basis, and then correct those classifications by constructing a tubelet which temporally links the object across the sequence of images. This enables poor quality frames or errors in classification to be rectified by simultaneously leveraging all captured views of the object. The system can identify incorrect classes, blurry frames, among others and determine, based on the classifications of the object in the tubelet, to update the object's classification and/or a confidence score for each frame.

The system may be applicable to any ATR use case. The system may be applicable to Unexploded Ordnance (UXO) clearance in order to mitigate hazards where drones may survey an area at a certain altitude for collecting video in a lawnmower-type pattern to detect UXOs. The system may be applicable to Battle Damage Assessment, or for Disaster Response. The system may be applicable for finding injured soldiers after battle, or finding injured civilians after a natural disaster.

The ATR system may employ advanced algorithms in conjunction with machine learning (ML) and artificial intelligence (AI) techniques to enable autonomous, real-time object recognition. Open Vocabulary Object Detection (OVOD) capabilities may be integrated to support dynamic class extension at inference time, allowing non-technical users to specify novel target categories using natural language descriptions and/or exemplar images. As explained, this is achieved without requiring model retraining, thereby facilitating rapid operational adaptability in dynamic or evolving environments. Moreover, the ATR system is generalizable, in that the same system may be applied in multiple scenarios and applications.

Further, to avoid ambiguity, the system can include an additional feedback mechanism to include contrastive descriptions to account for negative counter examples. This feedback mechanism may use pre-trained OVOD models, and images taken from standard OVOD benchmark datasets. By incorporating this feedback mechanism, non-technical users' class descriptions improve, thereby producing higher-performing, adaptable, and sustainable VLM-based ATR systems.

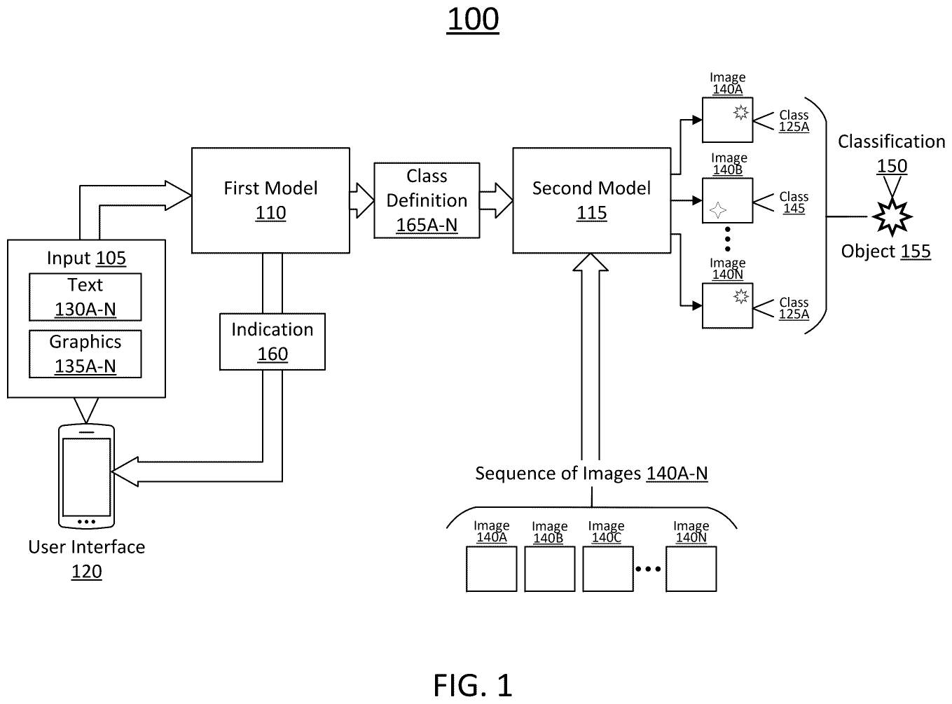

FIG. 1 depicts a diagram of a system 100 for receiving input 105, defining classes, and detecting and classifying objects within a sequence of images based on the classes. The system 100 can include a first model 110, a second model 115, a user interface 120, an input 105, classes 125A-N, a sequence of images 140A-N, an object 155, or a classification 150, among others. In brief overview of the system 100, the second model 115 can receive the sequence of images 140A-N and detect and classify one or more objects within each image based on the classes 125A-N at least. In some cases, the second model 115 can classify an object within an image of the sequence of images 140A-N as one or more of the classes 125A-N, or as a class not included in the classes 125A-N, such as class 145. The first model 110 of the system 100 can generate the class definitions 165 based at least on the input 105. Embodiments may comprise additional or alternative components or omit certain components from those of FIG. 1, and still fall within the scope of this disclosure.

The system 100 can include one or more models, such as the first model 110 and the second model 115. The first model 110 and the second model 115, among other models which may be included in the system 100, can be one or more artificial intelligence models, algorithms, software code, or other such models for classifying, detecting, generating, or otherwise providing one or more outputs from one or more inputs. While referenced as a first model, second model, etc., it should be understood that such models may be combined, parsed, and otherwise handled by the processors described herein.

The first model 110 can receive the input 105 and generate one or more class definitions 165A-N. The class definitions 165A-N (also referred to herein as the class definition(s) 165) can be a curated set of the inputs 105 for providing to the second model 115. In some cases, the class definitions 165 can be referred to as a coreset. The input 105 may include natural language from an end user. The input 105 may be received via an interface, speaker, etc., and may be one of many forms including a haptic input, textual input from a keyboard, audible input, etc.

The first model 110 can receive the input 105 to generate one or more of the class definitions 165. The input 105 can be or include a selection of media to provide to the first model 110 via the user interface 120. The input can include text 130A-N, graphics 135A-N, or other forms of media such as audio, inertial measurement unit data, haptic feedback, etc. The text 130A-N can include labels, identifiers, strings, natural language textual descriptions, or other forms of alphanumeric in plain text language to describe an object. In some cases, the text 130A-N includes a label which may identify a class of the classes 125A-N or a class not included in the classes 125A-N (e.g., the class 145). The graphics 135A-N can include photographs, drawings, animations, or other visual indicators of an object (e.g., a desired target object to be detected), with or without the text 130A-N.

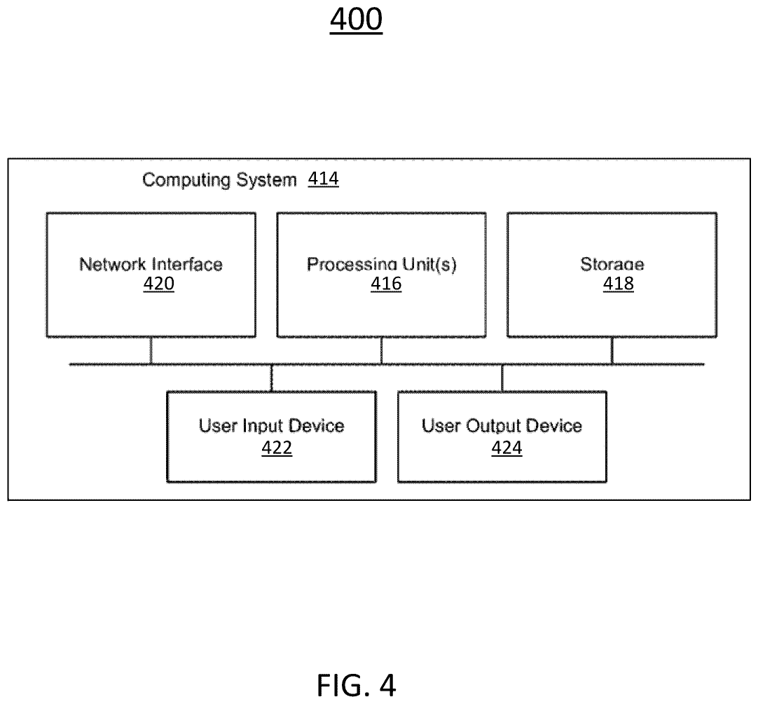

The first model 110 can receive the input 105 through a user interface 120 operating on a device such as a computer, tablet, cellphone, microphone, among others such as described with reference to FIG. 4. In some cases, the user interface 120 can interface or couple with a microphone, recording device, keyboard, touchscreen, or other form of user input device. The first model 110 can receive the input 105 at any time. The first model 110 can receive multiple inputs 105 at different times. The first model 110 can continuously generate the class definitions 165A-N based on the received input(s) 105. For example, the first model 110 can generate a first set of class definitions and subsequently receive one or more inputs to generate a second set of class definitions. The first set of class definitions can include or overlap with the second set of class definitions. In some cases, a subsequent input can relate to or too closely match a class or class definition such that a second class or class definition defined from the input is not discernable from a first class not defined with the input.

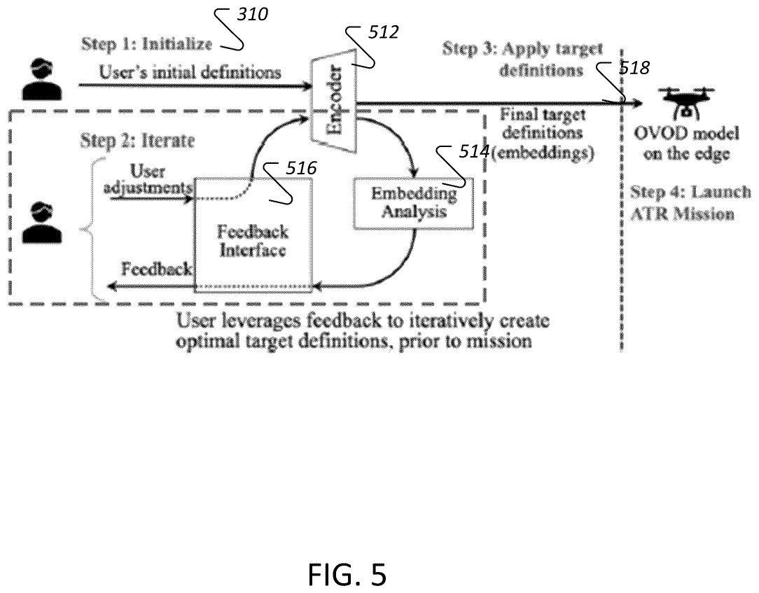

The first model 110 can generate the class definitions 165 to enable a balance of diversity and quality between each class of the classes 125. For example, the first model 110 can determine that one or more graphics 135A-N and/or texts 130A-N of the input 105 relates to the same or a similar object based on a comparison of features within the graphics 135A-N and/or the texts 130A-N provided as input. For example, the first model 110 can compare features such as language within the text 130A-N, coloration, pixels, etc. The first model 110 can generate an embedding of the input(s) 105. In some cases, the first model 110 can determine a cosine similarity or other metric between the input(s) or the embeddings of input(s) 105. In some cases, the first model 110 can determine a cosine similarity or other metric between subsequent input(s) and the class definitions 165A-N. This is also discussed in more detail with respect to FIG. 5 below.

The first model 110 can determine, based on a comparison of the features of the input 105, that one or more texts 130A-N and/or graphics 135A-N of the input 105 or of a prior input are the same input 105 or a superfluous input. For example, a first graphic 135A and a second graphic 135B can be the same graphic (i.e., features of the input are above a threshold indicating similarity of inputs). The first model 110 can prune, curate, or delete superfluous graphics 135A-N or texts 130A-N to ensure a diversity in the classes 125A-N, i.e., to ensure the features within duplicate exemplars are not over-represented.

In some cases, the inputs 105 may not describe differing objects with enough description to differentiate between the objects for generating the class definitions 165. For example, a first graphic 135A with an accompanying label can be above the threshold similarity as compared to a second graphic 135A with an accompanying, different label. In this example, the first and second graphics may not be distinguishable enough from each other to generate the class definitions 165. The first model 110 can determine that the one or more inputs 105 describing different objects are not described enough to generate differing classes for each object. For example, the first model 110 can generate an embedding for each input and determine that a cosine similarity is above a threshold similarity. The user may be provided, via the user interface, a ranking of all pairwise similarities. The user may then iteratively adjust the class definitions for the pairs of classes that are most similar in order to make them more distinguishable. If the user accepts the system's feedback, the given pair would likely become less similar, and the system re-ranks all of the pairs. The user may iterate through all of the pairs until the user is satisfied.

The first model 110 can compute and provide an indication 160 of the cosine similarity via the user interface 120 or other display device. In some cases, the model 110 can provide the indication 160 subsequent to determining that a cosine similarity for two or more inputs is above a threshold similarity. For example, the indication 160 can be a feedback indication 160 (also referred to and discussed herein as feedback mechanism 312). The feedback indication 160 can prompt for different or more graphics and/or text to differentiate class definitions associated with objects. The user interface 120 can provide the indication 160 including presentation elements (e.g., graphics, text, audio, etc.) to update or change one or more inputs to generate the class definitions 165. This feedback mechanism is also described in more detail with respect to at least FIGS. 5-7.

The second model 115 can receive the class definitions 165A-N to detect one or more objects within one or more images of the sequence of images 140. The sequence of images 140 can be a video, still images, frames (at any frame rate or frequency), etc. The sequence of images 140 can include one image, or can include more than one image (e.g., 5, 100, 1500 images). The sequence of images 140 can include one or more of electro-optical images, infrared images, radar images, sonar images, ultraviolet images, visible light images, among others. In this manner, the second model 115 can receive any modality of images.

The second model 115 can receive the sequence of images 140 from one source or multiple sources. In some cases, the second model 115 can receive multiple sequences of images 140 from the same or differing sources. The source of images can include one or more image capture devices (e.g., cameras, video cameras), removable storage media (e.g., a flash drive, CD-ROM, etc.) among others. In some cases, the source of images is standalone (e.g., only a camera) or coupled with other systems, such as a drone, vehicle, boat, goggles, among others. The source of images can transmit the sequence of images 140 in real time and/or record the sequence of images 140.

In some cases, each image of the sequence of images 140 can be associated with a time of occurrence. The time of occurrence can be a time of transmit of the images, recording of the images, receipt of the images by the system 100, among others. For example, the image 140B can occur at a second time after a first time and prior to a third time. To further this example, the image 140A can occur, be received, transmitted, etc., at the first time prior to the occurrence of the image 140B at the second time. Similarly, the image 140C can occur at the third time sequentially after the occurrence of the image 140B at the second time. In this manner, a temporal order to the sequence of images 140 is established.

The second model 115 can detect one or more objects within each image of the sequence of images 140. The second model 115 can be or include a multimodal language model (MMLM), also sometimes referred to as a multimodal large language model (MLLM), large multimodal models (LML), or a vision language model (VLM). In some cases, the second model 115 can detect and classify objects as an MMLM. In some cases, the second model 115 can include a multimodal open-vocabulary object detection model (MM-OVOD).

The second model 115 can detect and classify one or more objects for each image in the sequence of images 140. For example, the second model 115 can detect a first object in the image 140A and can classify that object as a class, such as the class 125A.

The second model 115 can receive the class definitions 165 to generate the class 125. The classes 125 can be labels for identifying, classifying, or labelling one or more objects within each image in the sequence of images 140, or a subset of the sequence of images 140. For example, a class of the classes 125 can identify a specific vehicle, uniform, equipment, among others, present in one or more of the images. The class 125 (also referred to herein as the class label(s) 125) can be text, a string, or another identifier. In some cases, the class label 125 is a data structure such as a vector or array.

In some cases, the second model 115 can generate an encoding for each graphic or text of the class definitions 165. The second model 115 can generate an encoding for any text 130A-N of the input 105 or for the class definitions 165 provided by the first model 110 from the input 105. For example, the second model 115 can encode the text 130 with a text-based encoder such as CLIP. For example, for a set of M text descriptions 130A-N, {sᵢ^{c}}^{M}ᵢ₌₁ for a class such as the class 125, each element of the set can be encoded with a CLIP text encoder, f_{CLIP-T}, and the text-based classifier for one or more of the classes 125 is obtained from the mean of these text encodings:

$${w}_{TEXT}^{C} = \frac{1}{M} {\sum }_{i = 1}^{M} {f}_{CLIP - T}$$

In some cases, the second model 115 can generate an encoding for any graphics 135A-N of the input 105. For example, the second model 115 can encode the graphics 135 with a visual encoder such as CLIP. For example, for a set of K graphics 135A-N, {xᵢ^{c}}^{K}ᵢ₌₁ for a class such as the class 125 to yield an encoding for each graphic of the input 105. In some cases, the second model 115 can provide these encodings (i.e., embeddings) to a multi-layer transformer to aggregate the graphic encodings to produce the class based on the graphics 135A-N.

In some cases, the class definitions 165 or the input 105 can include the graphics 135A-N and the text 130A-N. The second model 115 can represent a class based on a combination of the calculated text and graphic encodings. For example, the second model 115 may sum, average, weight, or otherwise determine the class based on the generated encodings for the text 130 and the graphics 135.

In some cases, the second model 115 can generate bounding boxes around one or more objects within the sequence of images 140. The second model 115 can generate the bounding boxes for the one or more objects within each image in the sequence of images 140, or a subset of the images. In some cases, the second model 115 can use the bounding boxes to determine the class 125 for each of the one or more objects in the images contained within each respective bounding box.

In some cases, the second model 115 can determine the class 125 of an object within an image of the sequence of images 140 by ranking one or more classes for the object and selecting the class based on the ranking. In some cases, the second model 115 can classify an object of the sequence of images 140 as the class 145.

The system 100 can be model-agnostic. Model-agnostic can mean that the system 100 can operate by inserting any of a variety of pre-trained MMLM models and/or with substituting one or more models with other models containing more or fewer text and image modalities. That is, the system 100 is agnostic to the VLM “under the hood”, and additional models may be swapped in as desired or as available. For example, the second model can perform object detection using a multimodal language model (MMLM). The second model can include any MMLM without altering functionality of the system 100. In some cases, the class labels 125, the class definitions 165, the inputs 105, or other data structures of the system can be stored in a data repository, such as described in conjunction with FIG. 4.

In some cases, the second model 115 can determine a classification 150 for an object 155. In some cases, the second model 115 determines that the object 155 is classified a threshold number of times as a first class, 125A, across the sequence of images 140. The second model 115 can generate the classification 150 of the object across the sequence of images 140 based on the occurrence of each class of the classes 125 across the sequence of images 140. For example, in some cases, the classification can be based on the largest number of occurrences of a class among the sequence of images 140. In some cases, the classification can be based on a ranking of confidence scores associated with each class for each image of the sequence of images. The classification 150 can be like or include any of the class labels 125A-N.

Thus, the ATR system may include feedback mechanisms, object detection, post-processing, and output visualization. The feedback mechanism may include natural language class definitions. The image stitching/mosaic is used to create maps of an area and a geospatial alignment and aggregation of results presented on top of the map/mosaic.

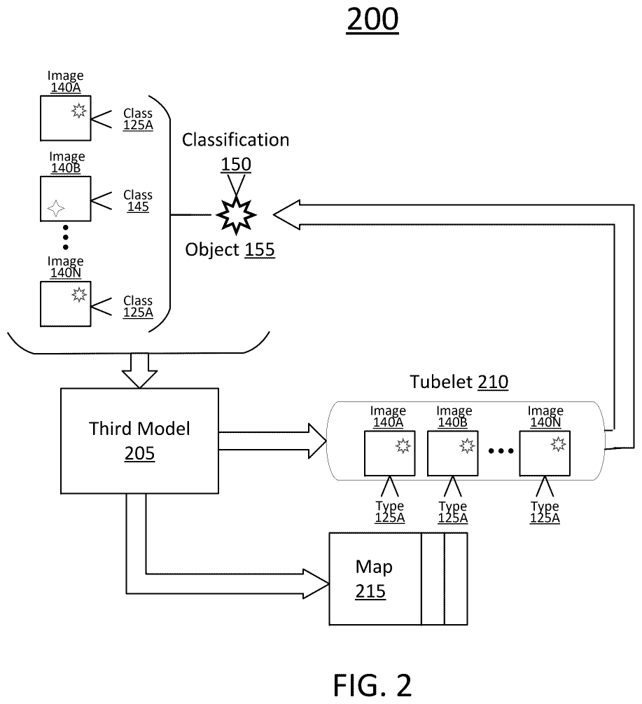

FIG. 2 depicts a system 200 for generating a tubelet 210 and map 215 based on the association of one or more objects with the classes 125. The system 200 can include or refer to components of the system 100 depicted in FIG. 1, and can operate with the system 100. In some cases, a third model 205 can accept the sequence of images 140 and its associated class labels 125 or 145 for each image. The third model 205 can, in some cases, perform sequential bounding box matching. For example, the third model 205 can generate a tubelet 210 by linking one or more sequential images of the sequence of images 140 based on at least an identification of an object in each image. The tubelet 210 can be a sequence of associated bounding boxes over time.

In some cases, the third model 205 can generate the tubelet 210 by determining that an object 155 is detected across at least a threshold subset of the sequence of images 140. The object 155 can be detected across the threshold subset of the sequence of images 140 based on a location of the object 155 within a given image of the sequence of images (e.g., such as given by a bounding box, coordinates, pixel matching, among others), the class 125 associated with an object detected within an image, or a combination thereof. The third model 205 can match the locations of the object 155 across the times of occurrence of the sequence of images 140 to form the tubelet 210.

The third model 205 can generate a map 215. In some cases, the map 215 can be a heat map of the object 155 over time. The map 215 can be referred to as a mosaic. In some cases, the map 215 can be a heat map of the object 155 displayed against a background generated by the third model 205. In some cases, the third model 205 can display the classification 150, the class label 125, or other information associated with the object 155. The third model 205 can display the tubelet 210 on the map 215. In some cases, the third model 205 can display the map 215 on UI 120 or on other display device.

In some cases, the third model 205 can determine that the predicted class of an object within a particular image differs from the predicted class of an object in images sequentially preceding and/or succeeding the particular image. The third model 205 can correct, change, or update a class associated with an object in an image by the second model 115 based on a ranking of the classes associated with the image and the sequential images. In some cases, the third model 205 can re-classify the class of the object 155 based on the changed classes from the tubelet 210. Reclassification of images in the sequence of images 140 can occur in near real time as each image of the sequence of images 140 is received. For example, each model can process one or more images as another model processing the same or different images. In some cases, multiple models can provide parallel processing capabilities. In this manner, errors from faulty sequences of images (e.g., missing frames, blurry frames, objects temporarily obstructed from view due to shadows, etc.) or misclassification can be rectified.

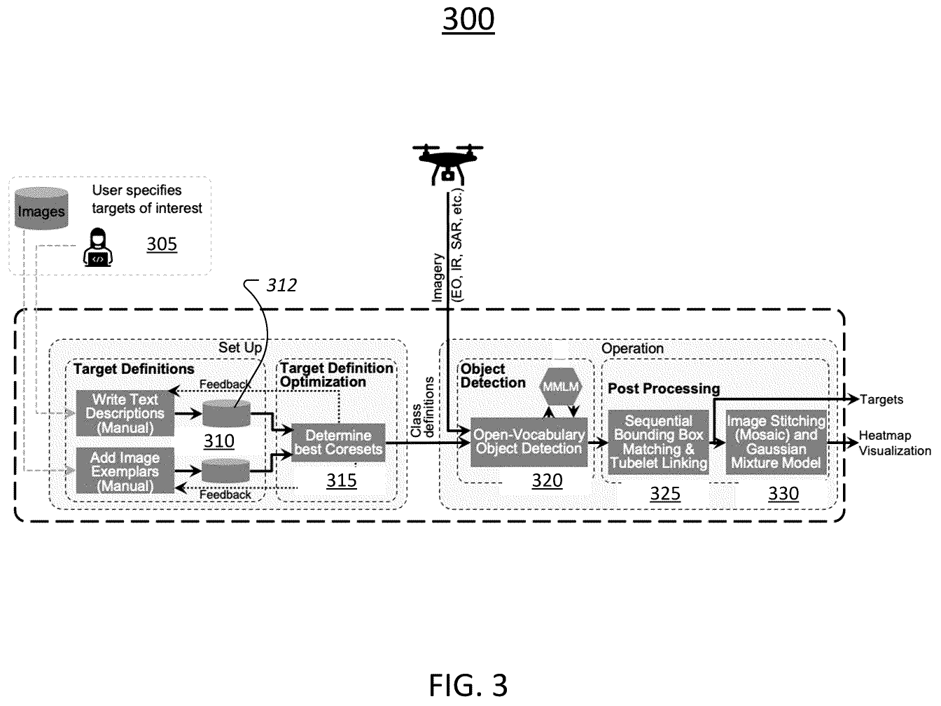

FIG. 3 depicts an example target recognition system 300 in accordance with one or more of the embodiments described herein. The system 300 can be like or include components of the systems 100 and 200 described herein.

As a generally overview of the system 300, a user 305 can provide input 310. Target definition optimization 315 can determine coresets based on the input 310. The target definition optimization 315 can provide feedback on the input 310 provided by the user 305. In some cases, the target definition optimization 315 can be like or include the functionality of the first model 110. In some cases, determining the coreset or best coresets can refer to curation of the input 310 to generate class definitions, such as by the first model 110. The target definition optimization 315 can provide the class definitions to object detection 320.

The object detection 320 can be like or include the second model 115. The object detection 320 can predict classifications (e.g., the classes 125) based on the class definitions 165. The object detection 320 can receive one or more images of a sequence of images and determine, based on the predicted classifications, the classes of objects within each frame of the sequence of images. The object detection 320 can generate a bounding box around one or more detected objects in each frame in the sequence of images.

Each detected object with an associated class can be provided to a sequential bounding box matching and tubelet linking algorithm/model during post processing 325. The sequential bounding box matching and tubelet linking can generate tubelets by linking sequential detected objects in the sequence of images according to their bounding boxes. The sequential bounding box matching and tubelet linking can correct classifications associated with each frame and generate a classification for an object within the sequence of images based on the classifications associated with the object in each image along the sequence of images. ATR visualization 330, which may include image stitching and Gaussian Mixture Model, may can generate a heat map based on the tubelet. Gaussian Mixture Models can also be referred to as Kernel Density Estimates.

Specifically, the user input 310 may include a user's initial definition or request. This may include something that identifies what the user is searching for, such as “find me all the tanks.” The input 310 may include or be part of the target definitions block. This block may be configured to receive text descriptions and images as part of the input. The block may include feedback mechanisms configured to further refine the user input 310.

Upon receiving user inputs 310, the system may determine the best coresets within a target definition optimization. The coresets can include class definitions. The system may improve class definitions via the feedback mechanisms.

Referring to FIG. 5, an iterative feedback mechanism 312 for enhancing natural language class descriptions may be included in the system 300. The feedback mechanism 312 may be the same or similar to the feedback indication 160 described above. As illustrated in FIG. 5, the target definitions block may receive the user's initial inputs 310. These inputs may proceed to an encoder 512 and an embedding analysis 514, similar to the first model 110 described above. The embedding may include translating the image information into a vector where each number in the vector represents a weight or value of a specific feature of the image.

A feedback interface 516 may allow the user to select embedding update. For the case where the user has just one target class, the feedback mechanism 312 allows the user to select the desired class, then analyzes encoded embedding to provide the user with context. The user can accept the system's feedback and provide adjustments to the class definition, such as adding positive or negative descriptions to differentiate the class of interest, or by subtracting concepts that are unrelated. The adjustments provided by the user are used to updates the class definition embedding. This can be used iteratively and when the user receives a satisfactory result, the system sends the improved class definition 518 to the edge processor. For the case where the user desires multiple targets simultaneously (e.g., both “passenger plane” and “military jet”), the system computes the pairwise similarity between all pairs of target classes. We compute the cosine similarity, which can result in values from −1 (maximally dissimilar) to +1 (maximally similar). The feedback, in this case, is presented as a ranking of most similar and least similar classes. This suggests to the user that they should modify the text descriptions to help discriminate between a given class and the classes whose embeddings are most similar, by either adding embeddings of text describing visual features unique to a given class or subtracting embeddings of text that are common between those classes.

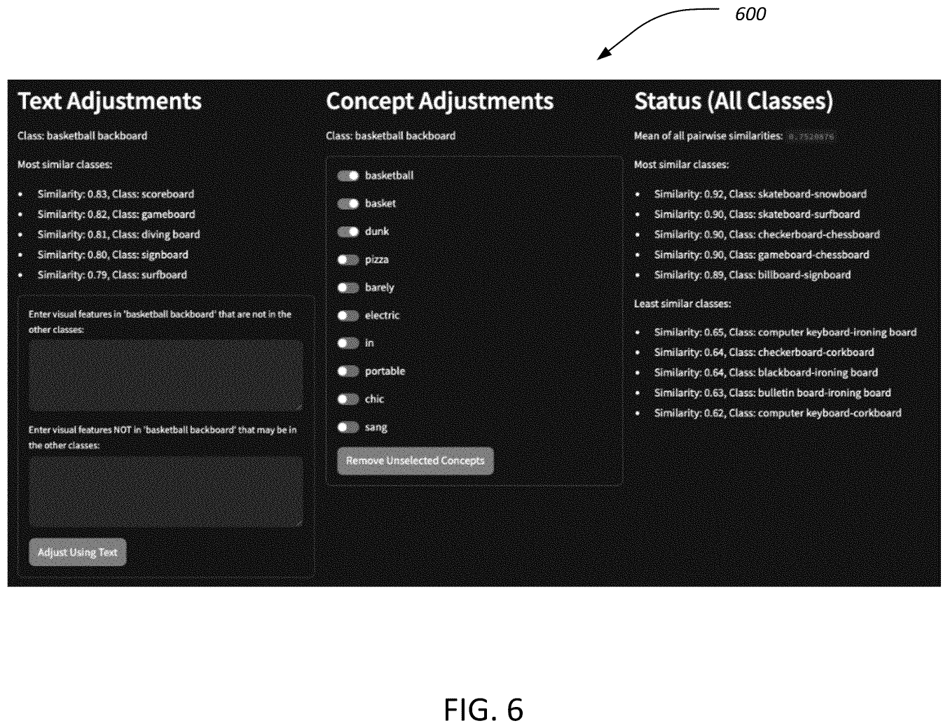

Referring to FIG. 6, an example user interface 600 presenting embedding updates by way of the feedback interface 516 is provided. The user interface 600 may be generated based on the user input 310 and may include top concepts related to the user input 310. The user may select and deselect certain concepts adjustments presented in the user interface 600. Such selections allow for weight to be given in the target description of the user input 310 to certain features. As shown, user adjustments may include providing text descriptions of distinguishing features, providing additional text descriptions of features that are not relevant, and unselecting irrelevant concepts.

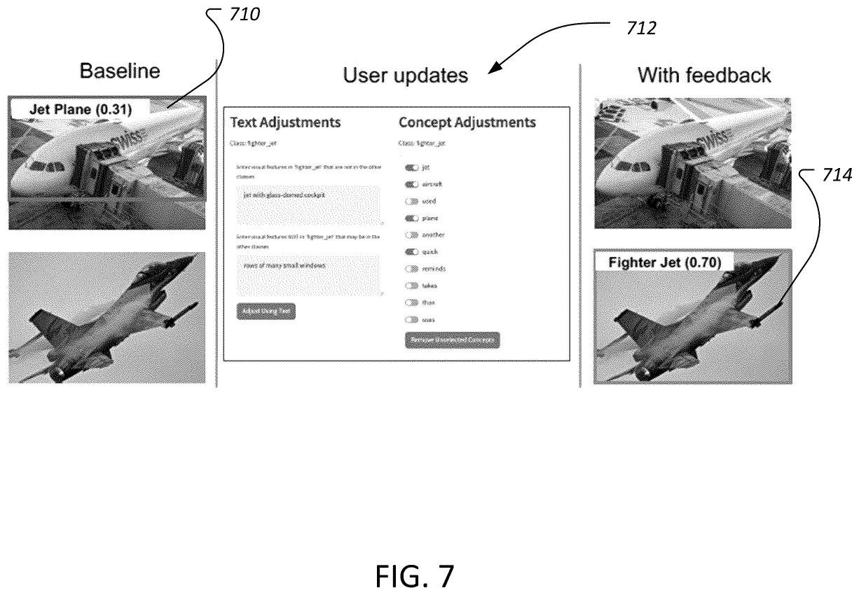

FIG. 7 illustrates a progression from a baseline selected image 710 from two different images, applying user updates at an example interface 712, and a feedback selected image 714. With the user feedback, the system may differentiate between the passenger plane and the military jet.

To reiterate, the feedback mechanism analyzes the text embeddings corresponding to the user specified desired target, to identify the potential lexical ambiguity or polysemy and guides the user to provide text descriptions with higher discriminative power. Improved descriptive inputs and fewer misclassifications eliminate the need for additional energy-intensive training or fine-tuning for the system to perform well on nuanced targets. The analysis leverages several techniques, including inter-class similarity assessments and concept decomposition (using sparse linear concept embeddings) to identify ambiguities.

Referring back to FIG. 3, the object detection 320 can generate a bounding box around one or more detected objects in each frame in the sequence of images. The ATR system may integrate various VLMs to assess performance across various use cases. Two primary models included MM-OVOD and YOLO-World. Each model has various strengths and weaknesses or limitations. The ATR system may select a model based on a specific application. Such selection coupled with the natural language class definitions provides for more accurate classifications.

At the post processing 325, each detected object with an associated class estimate can be provided to a sequential bounding box matching and tubelet linking algorithm/model. The sequential bounding box matching and tubelet linking can generate tubelets by linking sequential detected objects in the sequence of images according to their bounding boxes. Sequential bounding box matching may be coupled, in concert, with mosaic and kernel density estimation to track static objects (e.g., Unexploded Ordnances (UXOs)) from a moving perspective (i.e., a drone).

Sequential bounding-box matching may be used during post-processing in object detection to improve the accuracy of predictions. The algorithm matches bounding boxes in adjacent frames by their semantic similarity, and relative locations. The match quality, q, is defined by:

$$\frac{1}{q} = \frac{1}{similarity} = \frac{1}{IoU \times ( {V}_{{ctr}_{\text{?}}} \cdot {V}_{{ctr}_{\text{?}}} )}$$

$$\text{?} \text{indicates text missing or illegible when filed}$$

where the Intersection over Union (IoU) is multiplied by the dot product of the scoring vectors of the bounding boxes in the denominator. In this implementation, the drone's high velocity combined with a low frame rate frequently resulted in an IoU of 0.0 between frames. The IoU is replaced with the reciprocal of the distance between the boxes' centroids, 1/_{dc1,c2}. Matched bounding boxes in adjacent frames are candidates for detections of the same object and may form tubelets across multiple frames of the video. After all the tubelets have been formed, the scoring vectors for the bounding boxes of each tubelet are averaged and used to re-score the classifications. The library provides scores of all classes per detection, instead of only the highest classification score. This re-scoring successfully leverages the context from multiple frames to improve classification performance.

After the set of tubelets are created, two tubelets are linked into a longer tubelet when there is a gap of n frames. The parameter κ controls the maximum gap between tubelets to permit linking them. When κ=1, a gap of size g=κ−1=0 frames is realized, or just the normal tubelet creation with no linking. With κ=2, tubelets are linked with a gap of size g=1, and so on.

Still referring to FIG. 3, the ATR results visualization 330 may include image stitching and Gaussian Mixture Model to generate a heat map based on the tubelets. The ATR system also enables consideration of additional views of the same region that are separated in time (non-contiguous sequences of frames). This occurs when the drone scans the runway using a “lawnmower” pattern and sees an object on one pass, then turns around and sees the same object from the other direction. An increase in both detection and classification performance increases for cases where an object may be occluded or caught in a shadow from one perspective but clear when viewed from another. False-alarm density, D_{d}^{FA}, is computed when multiple passes over the same area are aligned, to not double-count false UXO detections at the same locations (to properly normalize to area). As such, the D_{d}^{FA} may be computed using the mosaic technique. The D_{d}^{FA} is explained further below.

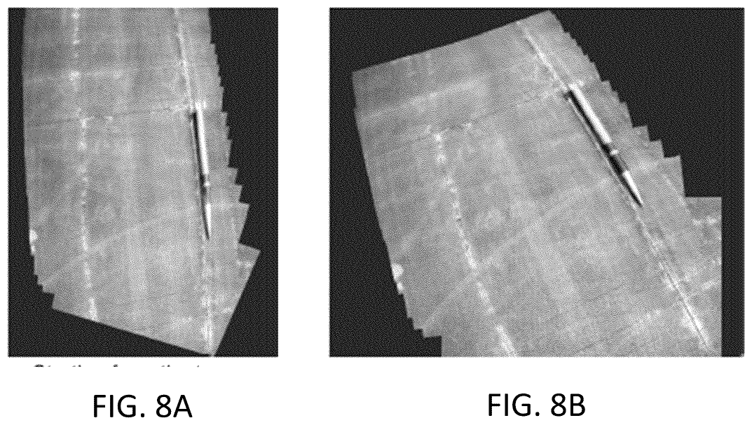

FIGS. 8A and 8B illustrate examples of different mosaics built from the same video frame but FIG. 8A is built from the top frame down and FIG. 8B is built from the bottom frame up. These illustrations demonstrate the problem of diminution or expansion with conventional systems.

Conventional systems attempt to rectify this problem with homographic transformations based off a starting image. This solution is constricted to images where the downward angle of the camera for the starting image is exactly orthogonal to the surface, i.e., photographing from directly overhead. When an initial frame is taken even just a few degrees from orthogonal, the result is a diminution (or expansion) as the subsequent frames are squeezed (or stretched) to continue the perspective of the first frame, as evident by FIGS. 8A and 8B. In addition, for the case of object detection from overlapping frames, it is important that the detected object's locations within the frames are transformed to the same location in the mosaic, rather than just the focusing on the stitched borders.

Thus, stitching video frames together in a mosaic as in the system described herein avoids diminution or expansion of the resulting mosaic. The mosaic may provide a holistic view of the search area containing the actual targets rather than a stale satellite image that may not contain targets. To achieve this, the system disclosed herein applies two-step procedure in which an initial rough pass is made using a translational transformation, so that a rough mosaic is created without any diminution. A second pass using the output of the first pass as the base image is then performed. While performing the stitching, the homographic transformation and translation matrices are saved into a list for each frame. These transformations are then applied to all the detections on each image such that each detection lines up with its location in the mosaic.

Next, the system provides an overlay by building a 2D Gaussian Kernel Density Estimate (KDE) with the Gaussians' σₓ and σ_{y} proportional to the detected bounding boxes' widths and heights, and Gaussian amplitudes equal to the classification confidences. This overlay aggregates where the ATR system detected targets in subsequent frames and multiple drone passes, with the brightest spots representing areas with the highest cumulative confidence from all overlapping frames.

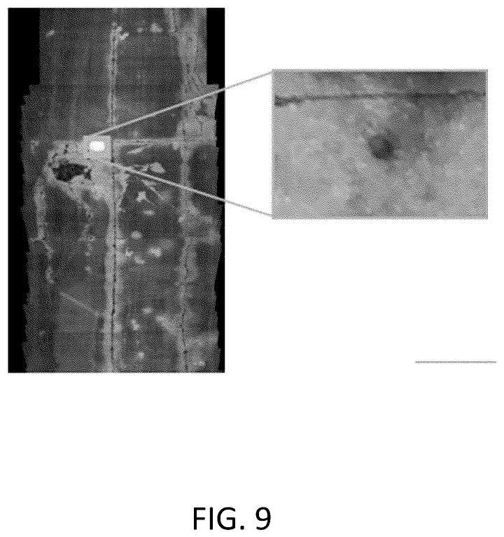

FIG. 9 illustrates an example of the system output mosaic stitched without a diminution (or expansion) and an overlay heatmap of our aggregated object detection results from several overlapping image frames. The heatmap overlay corresponds to aggregated detections across several frames. The boxes denote ground-truth locations of UXOs. Thus, the result is a visualization of the search area that is less sensitive to one-off false alarms and gives the user a holistic overview of the field.

The performance of the ATR system may be evaluated several ways. In one example, the probability of detecting an object (e.g., a UXO) is defined as:

$${P}_{d} = \frac{{N}_{d}^{True}}{{N}_{T}}$$

where N_{d}^{True} is the number of detected UXO objects, and N_{T} is the ground truth number of target UXO opportunities. Here, the classification is not considered, such that any class with c∈C_{UXO} is considered a true UXO detection, even if it is misclassified. The false alarm density for detections is defined as:

$${D}_{d}^{FA} = \frac{{N}_{d}^{False}}{A}$$

where N_{d}^{False} is the number of falsely-detected objects that do not correspond to the ground truth UXO locations and are classified with c∈C_{UXO}, and A is the area of the airfield runway encompassed by all the image frames in the video. In one example, data consisting of runway segments of 140 feet (35 m) wide by 400 ft (122 m) long, resulting in an area, A=4,270 m² were used. The probability of correct classification is defined as:

$${P}_{c} = \frac{{N}_{c}^{Correct}}{{N}_{d}^{True}}$$

which measures the proportion of correct classifications given our true detections.

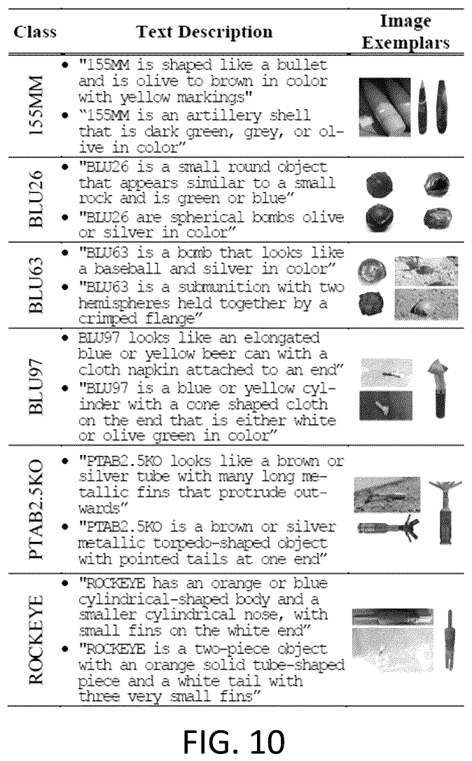

FIG. 10 illustrates an example table listing example classes, text descriptions, and image exemplars for a notional application of nuanced target recognition system applied to UXO detection.

MM-OVOD, as explained above, allows users to define classes using natural language text descriptions, or image exemplars, or both. For each class, natural language text descriptions describing the visible attributes of the classes are included. The descriptions may include unique visible qualities specific to each class, such as a color, geometric shape, and the distinct physical appearance. The optional image exemplars depicting the target classes are composed of images that are depicting two and three-dimensional representations of objects, and enhanced images with background noise added to represent the realistic imagery photographed by a drone. FIG. 10 shows the some of the text descriptions and image exemplars for the UXO classes.

Returning back to FIG. 4, FIG. 4 illustrates a block diagram 400 of a computing environment according to an example implementation of the present disclosure. Various operations described herein can be implemented on computer systems. In some embodiments, the ATR system, including the first model 110, the second model 115, and the third model 205 can be implemented by the computing system 414. These models and systems may include the target definitions and optimization, object detection and post processing of FIG. 3. Computing system 414 can be implemented, for example, as a consumer device such as a smartphone, other mobile phone, tablet computer, wearable computing device (e.g., smart watch, eyeglasses, HWD), desktop computer, laptop computer, or implemented with distributed computing devices. The computer system 414 can be a specialized computing system for performing the functionalities described herein. One or more components of the computer system 414 can be distributed. For example, a component of the computer system 414 can be located on a drone and can remotely communicate with other components of the distributed computing system 414. In some embodiments, the computing system 414 can include conventional computer components such as processors 416, storage devices 418, network interfaces 420, user input devices 422, and user output devices 424.

Network interface 420 can provide a connection to a wide-area-network (WAN) (e.g., the Internet) to which a WAN interface of a remote server system is also connected. Network interface 420 can include a wired interface (e.g., Ethernet) and/or a wireless interface implementing various RF data communication standards such as Wi-Fi, Bluetooth, or cellular data network standards (e.g., 3G, 4G, 5G, 60 GHz, LTE, etc.).

The network interface 420 may include a transceiver to allow the computing system 414 to transmit and receive data from a remote device (e.g., an AP, a STA) using a transmitter and receiver. The transceiver may be configured to support transmission/reception supporting industry standards that enables bi-directional communication. An antenna may be attached to transceiver housing and electrically coupled to the transceiver. Additionally or alternatively, a multi-antenna array may be electrically coupled to the transceiver such that a plurality of beams pointing in distinct directions may facilitate in transmitting and/or receiving data.

A transmitter may be configured to wirelessly transmit frames, slots, or symbols generated by the processor unit 416. Similarly, a receiver may be configured to receive frames, slots, or symbols and the processor unit 416 may be configured to process the frames. For example, the processor unit 416 can be configured to determine an object class within a frame and to process the frame and/or fields of the frame accordingly, such as in conjunction with the systems 100 and 200 described herein.

User input device 422 can include any device (or devices) via which a user can provide signals to computing system 414. Computing system 414 can interpret the signals as indicative of particular user requests or information. User input device 422 can include any or all of a keyboard, touch pad, touch screen, mouse or other pointing device, scroll wheel, click wheel, dial, button, switch, keypad, microphone, sensors (e.g., a motion sensor, an eye tracking sensor, etc.), and so on. In some cases, the UI 120 can present or operate through the user input device 422.

User output device 424 can include any device via which computing system 414 can provide information to a user. For example, user output device 424 can include display-to-display images generated by or delivered to computing system 414. The display can incorporate various image generation technologies, e.g., liquid crystal display (LCD), light-emitting diode (LED) (including OLED) projection system, cathode ray tube (CRT), or the like, together with supporting electronics (e.g., digital-to-analog or analog-to-digital converters, signal processors, or the like). A device such as a touchscreen that function as both input and output device can be used. Output devices 424 can be provided in addition to or instead of a display. Examples include indicator lights, speakers, tactile “display” devices, printers, and so on.

Some implementations include electronic components, such as microprocessors, storage and memory that store computer program instructions in a computer-readable storage medium (e.g., non-transitory, computer-readable medium). Many of the features described in this specification can be implemented as processes that are specified as a set of program instructions encoded on a computer-readable storage medium. When these program instructions are executed by one or more processors, they cause the processors to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processor 416 can provide various functionality for computing system 414, including any of the functionality described herein as being performed by a server or client, or other functionality associated with message management services.

It will be appreciated that computing system 414 is illustrative and that variations and modifications are possible. Computer systems used in connection with the present disclosure can have other capabilities not specifically described here. Further, while computing system 414 is described with reference to particular blocks, it is to be understood that these blocks are defined for convenience of description and are not intended to imply a particular physical arrangement of component parts. For instance, different blocks can be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is implemented. Implementations of the present disclosure can be realized in a variety of apparatus including electronic devices implemented using any combination of circuitry and software.

Using the systems and methods described herein, sequences of images, from a variety of modalities, containing blurry or dark frames can be assessed for target objects without dependence on a specific MMLM. Further, the systems and methods described herein do not necessitate retraining of the models for new or nuanced objects (e.g., objects not corresponding to initial target object classes) due to its ability to infer new classes based on prior class descriptions and multimodal semantic understanding captured in the underlying MMLM. The set of desired classes can be defined at run time by the user, without requiring model re-training, and without necessarily requiring image examples of the desired classes for training. The set of desired classes can be defined using language and/or other data modalities which may be different from the data modality in which the deployed system intends to recognize targets. While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system for nuanced target recognition, comprising one or more processors coupled with memory, the one or more processors configured to:
detect, using a second model, an object based on a sequence of images;
determine, using the second model, a class of the object for one or more of the images of the sequence of images, based on the images and an output of a first model, wherein the output comprises class definitions associated with a plurality of objects;
generate a classification of the object based on the determined classes for the one or more images; and
present the object and the classification on a display coupled with the one or more processors.

2. The system of claim 1, wherein the one or more processors are configured to:
identify, for each of the one or more images of the sequence of images, a bounding box around the object;
determine the class for each object of the one or more images based on each respective bounding box;
determine, using the second model and the class for each object of the one or more images, the classification of the objects from a plurality of classes.

3. The system of claim 2, wherein the one or more processors are configured to:
link, using a third model, the bounding boxes of each of the one or more images to generate a tubelet;
determine that a first image of the one or more images having a first class is sequential to a second image of the one or more images having a second class, wherein the second class is different than the first class; and
update the object in the first image to have the second class.

4. The system of claim 1, wherein the one or more processors are configured to:
receive an input describing a second object;
generate, using the first model, an embedding of the input;
determine, using the first model, a cosine similarity of the input based on the embedding; and
determine, using the first model, a second class definition to store with the plurality of class definitions.

5. The system of claim 4, wherein the input includes at least one of a text description of the second object or an image of the second object.

6. The system of claim 4, wherein the one or more processors are configured to:
determine the cosine similarity between the classes;
provide an indication of the cosine similarity via a display device; and
receive an update to the input.

7. The system of claim 1, wherein the one or more processors are configured to generate a background from the sequence of images via a mosaic or image stitching algorithm.

8. The system of claim 7, wherein the one or more processors are configured to overlay the object on the background based on an aggregation of each detection and classification.

9. The system of claim 1 wherein the sequence of images includes one or more of electro-optical images, infrared images, visible light images, ultraviolet light images, sonar images, radar images, or synthetic aperture radar images.

10. The system of claim 1, comprising an image capture device to capture the sequence of images.

11. The system of claim 1, comprising a drone configured to couple with the one or more processors.

12. The system of claim 1, wherein the one or more processors are configured to:
identify, using the second model, a second object;
determine, based on a plurality of classes and the second model, that a second class of the second object is not in the determined classes; and
present, via the display, an indication of the second class.

13. A method for nuanced target recognition, comprising:
receiving a sequence of images;
receiving a natural language description of a desired object;
analyzing the natural language description and generating a feedback interface including at least one initial classification and at least one adjustment option;
receiving adjustments in response to the feedback interface;
refining initial classification based on the adjustments; and
providing the refined classification for object detection within the sequence of images.

14. The method of claim 13, comprising:
identifying for each of the one or more images of the sequence of images, a bounding box around the object.

15. The method of claim 14, wherein analyzing user input includes embedding the input and determining a cosine similarity of the user input based on the embedding.

16. The method of claim 15, wherein the feedback interface includes a ranking of most similar and least similar classes.

17. The method of claim 16, further comprising determining that the cosine similarity is above a threshold similarity.

18. A non-transitory computer-readable medium having instructions embodied thereon, the instructions to cause one or more processors to:
identify an object based on a sequence of images;
identify, for each of the one or more images of the sequence of images, a bounding box around the object,
generate a tubelet of multiple ones of the sequence of images,
overlay a Gaussian Kernel Density Estimate proportional to the dimensions of each bounding box,
aggregate the ones of the sequence of images including the object based on the overlay to generate a heat map representation of overlapping frames.

19. The non-transitory computer-readable medium of claim 18, wherein the instructions cause the one or more processors to:
determine a class for each of the one or more images based on each respective bounding box;
determine a classification of the object from a plurality of classes.

20. The non-transitory computer-readable medium of claim 19, wherein the instructions cause the one or more processors to:
determine that a first image of the one or more images having a first class is sequential to a second image of the one or more images having a second class, wherein the second class is different than the first class; and
update the first image to have the second class.
